(19) United States
(12) Patent Application Publication
(10) Pub. No.: US 2008/0168113 A1
(43) Pub. Date: Jul. 10, 2008

(54) Time blocks and customizable time blocks

(75) Inventors: Robert Hickling, San Francisco, CA (US); Chinhao David Lee, Mountain View, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/650,283

(22) Filed: Jan. 5, 2007

(51) Int. Cl. G06F 17/30

(52) U.S. Cl. 708/112

(57) ABSTRACT

Techniques are described herein for providing a plurality of graphical elements, independent of any calendar location, associated with a distinct set of predefined data describing at least one characteristic of a calendar event comprising a plurality of characteristics. The predefined data may be user-specified. The graphical element is activated, such as by clicking or dragging, and in response to the activation, a proposed calendar event is generated that has a first set of one or more calendar event characteristics based on the predefined data associated with the graphical element. User input is received defining a second set of one or more calendar event characteristics that are not associated with the graphical element, and the proposed calendar event is saved in association with a particular calendar location.

### FIELD OF THE INVENTION

The present invention relates to personal calendaring and, more specifically, to fixed and customizable predefined calendar events.

### BACKGROUND

Personal calendaring systems exist to alert people about upcoming events, birthdays, appointments, and other events that take place at a scheduled time. Prior to the popularization of computer technology, personal calendars were on paper and written with pencil or pen. Placing commonly occurring events on this type of calendar was extremely time-intensive, editing was difficult, and the calendars took up significant space in order to hold all the necessary information.

Computerized calendaring systems, such as Microsoft Outlook, solved many of these problems by being easily editable and kept in digital format. Online calendaring systems now exist that make personal calendars available to users anywhere in the world where an Internet connection is available.

A common need with regard to personal calendaring systems is that a user often has repetitive appointments and activities to schedule, and some but not all information about the event is known. For example, a user may have a yoga appointment three times a week that lasts for one hour, but not know which days or times the appointment will take place until a week before the event, or have a staff meeting that takes place every Tuesday for one hour, but not know the exact time and location until actually scheduling the event on the calendar. Scheduling these events can be tedious, because some of the information for each appointment is consistent and scheduling them requires duplication of effort. In the above examples, each yoga appointment would have the same duration and location, and the staff meeting would have the same day and duration.

One approach to calendaring is for the user to schedule each event by clicking a “New Event” option or similar element, and fill out all the details about the event such as start time, duration, place, day, etc. As already mentioned, this approach is tedious and repetitive where certain events have some consistently recurring details.

Another approach to calendaring has “recurring events” that a user may specify to occur every X number of days, or on certain days of the week, month, or year for a predefined number of times. The disadvantage to this approach is that not all events share the same information except just for a date and time known well in the future. For example, a person may know that she is going to the gym three times a week for an hour each time, but not know the day or starting time until actually scheduling the appointment. A “recurring event” would not be optimal for scheduling this event, because each individual entry would have to be edited to reflect the correct day and starting time once these details are known. If not every event occurs on a date and time known well in the future, this approach involves a significant amount of work.

Therefore, an approach for providing predefined customizable events that may be entered onto a calendar, which does not experience the disadvantages of the above approaches, is desirable. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system according to an embodiment of the invention;

FIG. 2A is a diagram illustrating an approach for using time blocks according to an embodiment;

FIG. 2B is a diagram illustrating the use of time blocks according to an embodiment;

FIG. 2C is a diagram illustrating the creation of a calendar event as a result of the activation of a time block, according to an embodiment;

FIG. 2D is a diagram illustrating the use of a customizable time block according to an embodiment;

FIG. 2E is a diagram illustrating the creation of a calendar event as a result of the activation of a customizable time block, according to an embodiment;

FIG. 3 is a flowchart illustrating the functional steps of using time blocks according to an embodiment; and

FIG. 4 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

“Time blocks” are predefined, user-customizable forms that allow users to record events on an electronic calendar with minimal data entry. At a minimum, time blocks have a predefined time duration: for example, a one-hour time block, when used for a specific event, can start at 9 A.M. and end at 10 A.M. (the actual start and end times depend on the time specified by the user or calendar, when activating the time block). A time block is different from a template in that it is sensitive to time in the context of a calendar.

“Customizable time blocks” are time blocks with calendar event characteristics that may or may not include event duration, but may also include other event details. Customizable time blocks improve efficiency by providing predefined calendar event characteristics of an event. Users may define as many details as possible in a customizable time block (subject to any restrictions set by the event form). Upon activating the customized time block, all predefined details are populated in the new event form. Users may change the populated details, add further details, or leave the event as is.

According to an embodiment, a time block, customizable or not, is a graphical element with which users can interact and which is displayed independent of any calendar location. For example, a graphical element comprising a “time block” is displayed and has no relation to any particular time, day, month or year of a calendar. Users may drag a time block onto a view of the calendar to create an event on a certain date and/or starting time. Users can also click on the time block to create a new event with the predefined time block data. According to an embodiment, once an event is created and saved, it loses its relationship with the original time block; therefore, any changes to the time block in the future will not affect the details of the events created in the past.

According to an embodiment, data available in time blocks is subject to the calendar application. A calendar application defines the data and attributes available to a time block and which data triggers additional workflows. According to an embodiment, the event data that the calendar will support is defined and time blocks are configured from a subset of the event data. Thus, time blocks are independent system objects that inherit data definition from event objects.

According to an embodiment, a plurality of graphical elements independent of any calendar location are displayed, where each graphical element is associated with a distinct set of predefined data describing at least one characteristic of a calendar event comprising a plurality of characteristics. The predefined data may be user-specified. The graphical element is activated, such as by clicking or dragging, and in response to the activation, a proposed calendar event is generated that has a first set of one or more calendar event characteristics based on the predefined data associated with the graphical element. User input is received defining a second set of one or more calendar event characteristics that are not associated with the graphical element, and the proposed calendar event is saved in association with a particular calendar location.

According to an embodiment, user input is received and stored describing details of a calendar event, where the calendar event is defined by a number of details, and the user input is a subset of the entirety of details describing a calendar event. The user input is associated with a graphical element and upon activation of the graphical element, a window is displayed into which details describing a calendar event may be entered into blank data fields, and the particular details already described by the user input are populated in the appropriate data entry fields. The calendar event is then saved.

### Architectural Overview

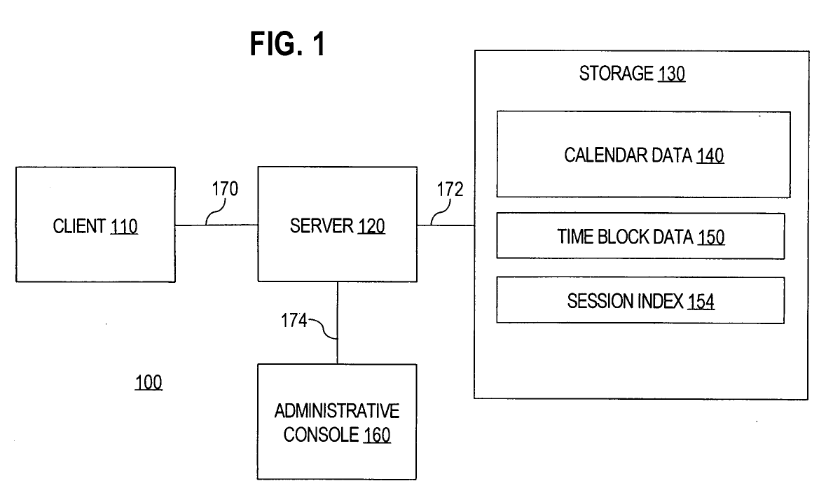

FIG. 1 is a block diagram of a system 100 according to an embodiment of the invention. Embodiments of system 100 may be used to provide and utilize time blocks and customizable time blocks in accordance with an embodiment of the invention. A user may define a time block or customizable time block using the techniques described herein, activate a time block or customizable time block in a calendaring system and edit the time block if needed.

In the embodiment depicted in FIG. 1, system 100 includes client 110, server 120, storage 130, calendar data 140, time block data 150, a session index 154, and an administrative console 160. While client 110, server 120, storage 130, and administrative console 160 are each depicted in FIG. 1 as separate entities, in other embodiments of the invention, two or more of client 110, server 120, storage 130, and administrative console 160 may be implemented on the same computer system. Also, other embodiments of the invention (not depicted in FIG. 1), may lack one or more components depicted in FIG. 1, e.g., certain embodiments may not have a administrative console 160, may lack a session index 154, or may combine one or more of the calendar data 140, time block data 150, and the session index 154 into a single index.

Client 110 may be implemented by any medium or mechanism that provides for sending request data, over communications link 170, to server 120. Request data specifies a request to create or utilize a time block or customizable time block within a calendaring interface. This request data may be in the form of a user clicking a button associated with a time block or customizable time block, selecting a menu option associated with a time block or customizable time block, and clicking and dragging a time block from a list or graphical repository of icons.

The server, after processing the request data, will transmit to client 110 response data that makes available for use or editing an instance of the requested time block or customizable time block. While only one client 110 is depicted in FIG. 1, other embodiments may employ two or more clients 110, each operationally connected to server 120 via communications link 170, in system 100. Non-limiting, illustrative examples of client 110 include a web browser, a wireless device, a cell phone, a personal computer, a personal digital assistant (PDA), and a software application.

Server 120 may be implemented by any medium or mechanism that provides for receiving request data from client 110, processing the request data, and transmitting response data that identifies the one or more requested images to client 110.

Storage 130 may be implemented by any medium or mechanism that provides for storing data. Non-limiting, illustrative examples of storage 130 include volatile memory, non-volatile memory, a database, a database management system (DBMS), a file server, flash memory, and a hard disk drive (HDD). In the embodiment depicted in FIG. 1, storage 130 stores the calendar data 140, time block data 150, and session index 154. In other embodiments (not depicted in FIG. 1), the calendar data 140, time block data 150, and session index 154 may be stored across two or more separate locations, such as two or more storages 130.

Calendar data 140 represents data defining a calendar and calendar event characteristics along with any associated events, appointments, and other items that the client 110 may request to view or obtain. Time block data 150 is data that defines one or more time blocks or customizable time blocks are described herein. Session index 154 is an index that may be used to determine which calendar data 140 and time block data 150 was requested and/or used by a particular user.

Administrative console 160 may be implemented by any medium or mechanism for performing administrative activities in system 100. For example, in an embodiment, administrative console 160 presents an interface to an administrator, which the administrator may use to add calendars to the calendar data 140, remove calendars from the calendar data 140, create an index (such as session index 154) on storage 130, or configure the operation of server 120.

Communications link 170 may be implemented by any medium or mechanism that provides for the exchange of data between client 110 and server 120. Communications link 172 may be implemented by any medium or mechanism that provides for the exchange of data between server 120 and storage 130. Communications link 174 may be implemented by any medium or mechanism that provides for the exchange of data between administrative console 160, server 120, and storage 130. Examples of communications links 170, 172, and 174 include, without limitation, a network such as a Local Area Network (LAN), Wide Area Network (WAN), Ethernet or the Internet, or one or more terrestrial, satellite or wireless links

### Time Blocks

“Time blocks” are defined as event templates with predefined time duration. For example, a one-hour time block may start at 9 A.M. and end at 10 A.M. According to an embodiment, a time block is a graphical element that users can click or drag onto a calendar. Upon activating the time block, either by clicking or dragging, an event form is initialized with the predefined data. Users can fill in additional event information to quickly record the event.

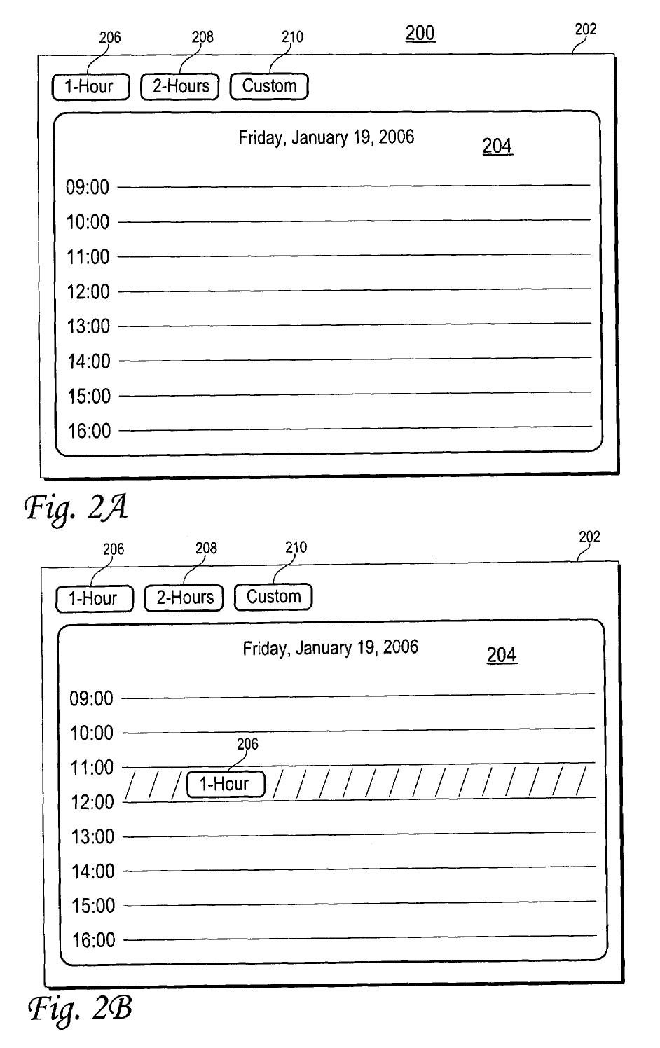

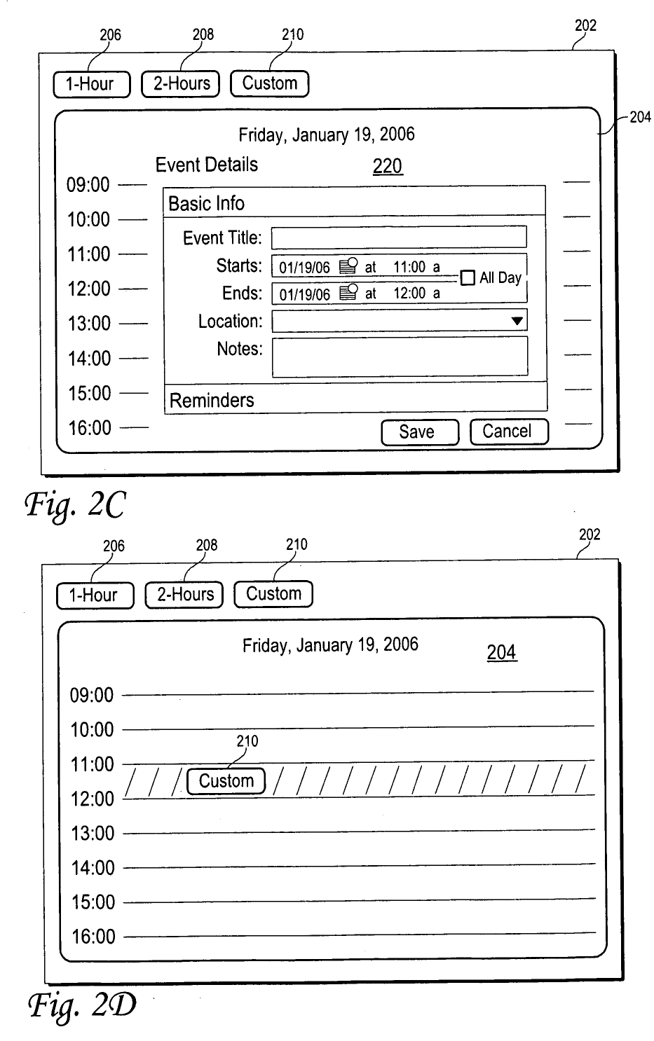

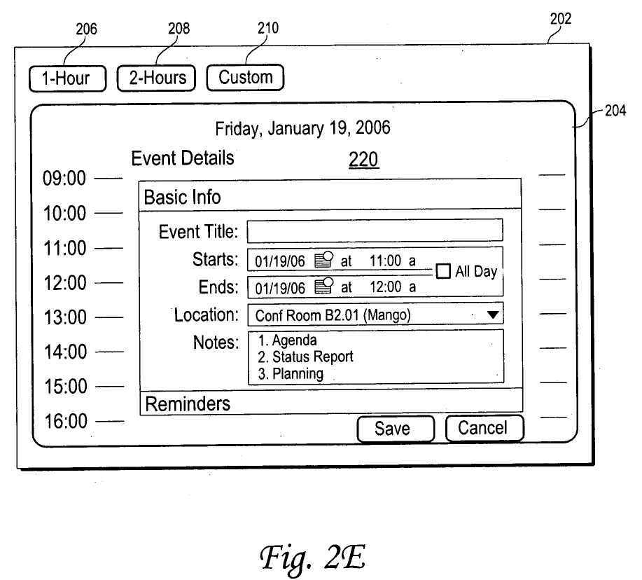

FIG. 2A is a diagram 200 illustrating an approach for using time blocks according to an embodiment of the invention. A calendar application 202 comprises a window with a day displayed to the user. The calendar application may be a stand-alone application executing on a computer system or a online application executed on a system as described above. In FIG. 2A, the calendar application 202 comprises a date display 204, which in this example displays one day, Friday, Jan. 19, 2006. Other embodiments are envisioned where more than one day is presented to a user. For example, a week, month or year may be presented, or any span of days chosen by a user. The display may change based upon the number of days chosen for display; for example, elements comprising individual days, weeks and months may be resized to fit within the available space on the display, or a subset of the chosen time interval may be displayed with elements such as buttons or arrows to enable a user to display the non-displayed intervals.

The portion of the display comprising the day 204 is subdivided into hourly intervals. According to other embodiments, depending on options chosen by a user or available space, each day may not be subdivided or may be subdivided into larger hourly intervals. In FIG. 2A, three time blocks 206-210 are displayed. A time block may be one or more graphical elements that exist independent of any calendar locations; for example, they have no relation to an hour, day, week or month on a calendar. A one-hour time block 206, a two-hour time block 208, and a customized time block 210 as described herein are displayed. The placement and appearance of the time blocks in FIG. 2 are for illustrative purposes only, as any number of arrangements or presentations may be utilized without limiting the approaches described herein. For example, there may be any number of time blocks 206-210 displayed, and more time blocks 206-210 may be available than can be displayed in the available screen area. According to alternate embodiments, graphical elements may be used to facilitate the viewing and selection of time blocks 206-210 that are not immediately visible. For example, the available time blocks 206-210 may be displayed in multiple rows, or a user may click on a graphical element such as an arrow that may be located at the end of a row of time blocks 206-210 to scroll the displayed time blocks 206-210 so that time blocks located “offscreen” will scroll into view and time blocks 206-210 located “onscreen” will scroll “offscreen.” A drop-down menu of available time blocks 206-210 may also be used, or a dialog box of available time blocks 206-210 may be displayed in response to user input.

FIG. 2B is a diagram illustrating the use of time blocks 206-210 according to an embodiment. A user may “click” on an available time block 206-210, in this case the one-hour time block 206, and “drag” the graphical element representing the time block 206-210 onto the date display 204. In the case of the date display 204 being divided into hourly portions, the time block 206 is dragged to the area just beneath the starting time. In the case of the date display 204 not being subdivided into hourly portions, the time block 206 may be dragged anywhere onto the date for which the event is to be scheduled. According to an embodiment, a portion or entirety of the date display 204 may be highlighted or otherwise visually enhanced to indicate that, upon user input such as releasing the mouse button, the time block 206 will be activated in the highlighted time interval or day. For example, in FIG. 2B, the one-hour time block 206 is being dragged onto the area between the 11:00 and 12:00 time division. The area between the time divisions is highlighted to indicate that if the time block 206 is released, an event lasting from 11:00 to 12:00 will be created. If the two-hour time block 208 has been dragged onto the date display 204 as illustrated in FIG. 2 between the 11:00 and 12:00 time division, the area between the 11:00 and 13:00 time divisions would be highlighted to indicate that if the time block 206 is released, an event lasting from 11:00 to 13:00 will be created. If the two-hour time block 208 is dragged onto the date display 204 between the 12:00 and 13:00 time divisions, an event lasting from 12:00 to 14:00 will be created, and time blocks of larger durations would operate in the same fashion. Alternatively, the graphical element representing the time block 206 may be clicked to activate it within a selected day, or a menu command may be used to activate a particular time block, or a keystroke combination.

FIG. 2C is a diagram illustrating the creation of a calendar event as a result of the activation of a time block, according to an embodiment. After the one-hour time block 206 is dragged and released onto the date display area 204, clicked on by a user, or otherwise activated according to an embodiment, a dialog box 220 within which event information may be entered appears. In FIG. 2C, this is illustrated as an “event details” dialog box 220. The purpose of the event details dialog box 220 is to enter details about a calendar event onto the calendar, so the appearance of the “event details” dialog box 220 in FIG. 2C is merely an example, and any numbers of variations are contemplated. For any of these contemplated stylistic or functional variations, the aspect of importance is that the time details of the event to be entered are already populated in the “event details” dialog box 220 based on the predefined data, in this case event duration, associated with the one-hour time block 206. Because the duration of the event is predefined based on the particular time block activated, the starting and ending time may be calculated and pre-populated based upon the time division associated with the time block when the time block is activated, as discussed above, and the date of the event may be determined based upon the day upon which the time block is dropped or which day is active in the calendar when the time block is activated. According to an embodiment, if there are no time divisions on the date display 204 when the time block is activated by dragging, clicking, or other technique, then upon the user entering a starting time in the event details dialog box 220, the ending time would be calculated and filled in based on the duration of the activated time block, and vice versa. Any amount of time is usable as a duration and the automatic calculation of starting and/or ending time as described above may be made for any amount of time associated with the time block.

### Customizable Time Blocks

“Customizable time blocks” are time blocks that allow users to further predefine event characteristics in addition to time duration. A user may define any characteristics of an event in the time block, such as title, comments, guests, reoccurrence, and location. Any possible event detail that may be entered into the specific calendar application may be defined in a custom time block. Each time the customized time block is activated, the predefined information is automatically populated in the event details dialog box, or any other type of input interface used by the specific calendar application. Users may change this information in the form without affecting the customized time block or events created previously with the customized time block.

FIG. 2D is a diagram illustrating the use of a customizable time block 210 according to an embodiment. A user may “click” on the customizable time block 210 and “drag” the graphical element representing the customizable time block 210 onto the date display 204. In the case of the date display 204 being divided into hourly portions, the customizable time block 210 is dragged to the area just beneath the desired starting time. In the case of the date display 204 not being subdivided into hourly portions, the customizable time block 210 may be dragged anywhere onto the date for which the event is to be scheduled. According to an embodiment, a portion or entirety of the date display 204 may be highlighted or otherwise visually enhanced to indicate that, upon user input such as releasing the mouse button, the customizable time block 210 will be activated in the highlighted time interval or day.

For example, in FIG. 2D, the customizable time block 210 is being dragged onto the area between the 11:00 and 12:00 time division. Based on the event duration associated with the customizable time block 210, an area between the time divisions is highlighted to indicate that if the time block 206 is released, an event with a duration associated with the customizable time block 210 will be created. For example, in FIG. 2D, if the customizable time block 210 being dragged onto the area between the 11:00 and 12:00 time division has a two-hour event duration associated with it, then the area between the 11:00 and 13:00 time divisions would be highlighted to indicate that if the customizable time block 210 is released, an event lasting from 11:00 to 13:00 will be created. If the customizable time block 210 is dragged onto the date display 204 between the 12:00 and 13:00 time divisions, an event lasting from 12:00 to 14:00 will be created, and customizable time blocks with larger associated durations would operate in the same fashion. Alternatively, the graphical element representing the customizable time block 210 may be clicked to activate it within a selected day, or a menu command may be used to activate a particular time block, or a keystroke combination.

FIG. 2E is a diagram illustrating the creation of a calendar event as a result of the activation of a customizable time block 210, according to an embodiment. After the customizable time block 210 is dragged and released onto the date display area 204, clicked on by a user, or otherwise activated according to an embodiment, a dialog box 220 within which event information may be entered appears. In FIG. 2E, this is illustrated as an “event details” dialog box 220. The purpose of the event details dialog box 220 is to enter details about a calendar event onto the calendar, so the appearance of the “event details” dialog box 220 in FIG. 2E is merely an example, and any numbers of variations are contemplated.

For any of these contemplated stylistic or functional variations, an aspect is that the time details of the event to be entered are already populated in the “event details” dialog box 220 based on the predefined data associated with the customizable time block 210. If the duration of the event is predefined based on the particular customizable time block 210 activated, the starting and ending time may be calculated and pre-populated based upon the time division associated with the customizable time block 210 when the customizable time block 210 is activated, as discussed above, and the date of the event may be determined based upon the day upon which the customizable time block 210 is dropped or which day is active in the calendar when the customizable time block 210 is activated. According to an embodiment, if there are no time divisions on the date display 204 when the customizable time block 210 is activated by dragging, clicking, or other technique, then upon the user entering a starting time in the event details dialog box 220, the ending time would be calculated and filled in based on the duration of the activated customizable time block 210, and vice versa. Any amount of time is usable as a duration and the automatic calculation of starting and/or ending time as described above may be made for any amount of time associated with the customizable time block 210.

Any details that may be associated with an event may be predefined in the customizable time block 210. In the example illustrated in FIG. 2E, the starting time (11:00 A.M.), the ending time (12:00 P.M.), the location (Conference Room B2.01 (Mango)), and notes (1. Agenda 2. Status Report 3. Planning) have been filled out automatically because that information is associated with the particular customizable time block 210 that has been activated on the selected day. An “Event Title” has not been predefined and may be edited by the user after creation of the event. The user may also edit the predefined information during or after creation of the event. Instead of having the starting and ending time predefined, a customizable time block 210 may have the duration defined and automatically calculate the starting and ending time as discussed above, and this information will appear in the event details dialog box 220 along with the predefined information.

According to an embodiment, a customizable time block may contain information describing other persons who are to be invited to the event created as a result of using said customizable time block to schedule an event. Once the event is created and saved, the electronic calendar of the invitee or invitees may be checked to see if they have any events conflicting with the created event. If not, a copy of the event created by the user may be created for the invitees and saved to their calendar. A notification may be sent to the invitees, and the invitees may decline the event. If one or more invitees have a conflict, then a notification may be created for the user describing the conflict and allowing the user to take action to reconcile the conflict.

According to an embodiment, once an event is created and saved, the event loses its relationship with the original time block; therefore, any changes to the customizable time block 210 in the future will not affect the details of the events created in the past. Likewise, any alteration of the details of an event created with a customizable time block 210 will not affect the customizable time block 210. Customizable time blocks offer users the flexibility to predefine any attribute available on the event form as utilized by the particular calendar application. An infinite number of customizable time blocks 210 may be created and made available to the user. According to an embodiment, a menu command such as “Create New Time Block” may be selected and a customizable time block 210 created thereby. According to an embodiment, each customizable time block may have a unique name associated with it that will be displayed on the graphical element representing the customizable time block 210 for ease in identification. For example, the customizable time block 210 in FIG. 2E may have a title of “Meeting” instead of “Custom.” The one-hour time block 206 may also be re-titled and edited to change its duration. The customizable time blocks 210 created by the user and/or provided to a user may likewise be edited to change any event detail associated with the time block. This may be accomplished in any number of ways; for example, a user may right-click on the customizable time block 210, select “Edit” from a resulting drop-down menu, and the template event details and title of the time block associated with the customizable time block 210 will appear and become available for editing and saving.

### Creating a Calendar Event with a Time Block

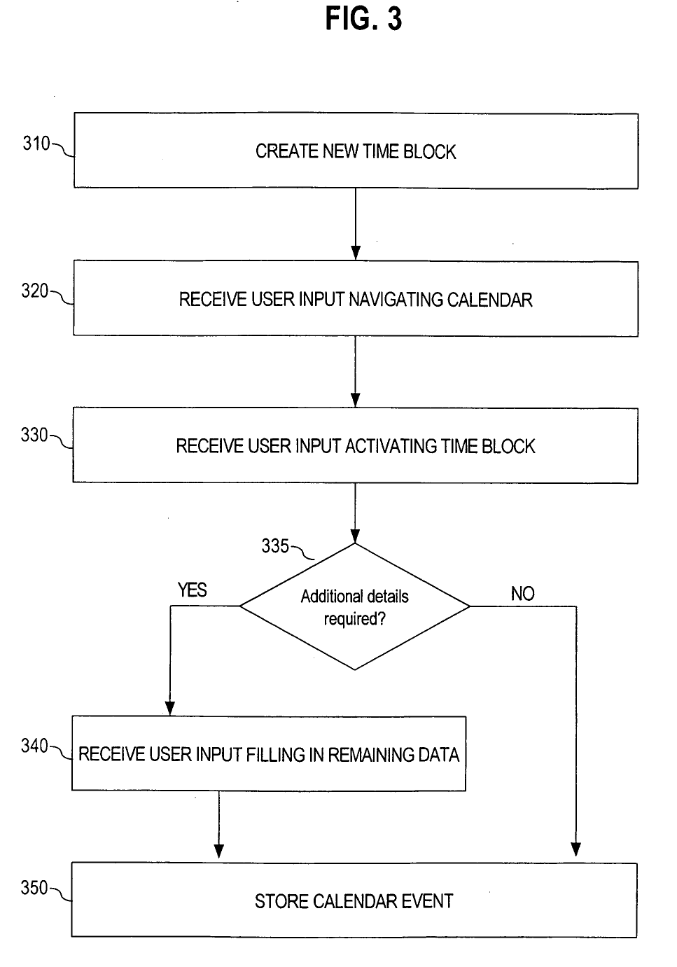

FIG. 3 is a flowchart 300 illustrating the functional steps of creating a calendar event with a time block according to an embodiment of the invention. The particular sequence of steps illustrated in FIG. 3 is merely illustrative for purposes of providing a clear explanation. Other embodiments of the invention may perform all or a subset of the various steps of FIG. 3 in parallel or in a different order than that depicted in FIG. 3.

Initially, in step 310, a new customized time block is created. According to an embodiment, a user selects a menu command and a dialog box is displayed into which details of the time block may be entered. For example, a user may create a customized time block titled “Gym,” in which a duration of one hour is defined, a place of “Ted's Gym” is defined, and a reminder one day before the event is requested. This is a distinct set of one or more user-specified calendar event characteristics. The customized time block is saved with the title “Gym,” and a new graphical element such as in FIGS. 2A-2E is created with a “Gym” label. According to an embodiment, customized time blocks, as well as time blocks, may appear in a different color or otherwise highlighted for ease of identification.

In step 320, a user wishes to create a calendar event scheduling an appointment at the gym. The user navigates to a portion of the electronic calendar where the day for the appointment is available. For example, the user may navigate to the specific day, such that an hourly division of the day is presented, or may simply navigate to a weekly or monthly view where the desired day is visible.

In step 330, the user activates the “Gym” customized time block. For example, the user may click on the graphical element associated with the “Gym” time block and drag the element to the day on the electronic calendar. If the element is dragged onto a display that contains hourly divisions of the desired day, the user may drag the element to the starting time desired for the appointment. Visual feedback such as highlighting may be used to assist the user in properly positioning the element. For example, if the user drags the element to the 11:00 A.M. hourly division on the desired day, and releases the element, then a new calendar event is created with the starting time dependent on the hourly division upon which the element was positioned, in this case 11:00 A.M. According to an embodiment, a window in which details of the event may be entered is displayed. An electronic calendar event is comprised of details such as start time, end time, title, and the like. The window has blank data entry fields into which these details may be entered.

Upon activation, a proposed calendar event is generated that has a first set of one or more calendar event characteristics that are based on the set of one or more user-specified calendar event characteristics associated with the graphical element. Because the time block already has data saved indicating a duration of one hour, the data field into which ending time is entered is populated with data, and the ending time is automatically calculated to be 12:00 P.M., the title “Gym” is entered into the title field of the event, the day of the event is automatically populated depending on the day upon which the graphical element is dropped, and a reminder is created according to the particular calendar workflow.

In step 335, if the user wishes to enter additional details about the event or edit details already filled into the event, then control proceeds to step 340; otherwise, control proceeds to step 350. In step 340, remaining event details not defined by the time block, such as invitees, notes, and any other details, are left blank for the user to enter for this particular event. User input is received defining a second set of one or more calendar event characteristics not associated with the graphical element. If the graphical element associated with the time block was activated by being clicked, then in this case necessary details to be filled in by the user would be the day and starting or ending time. Because the time block is associated with an one-hour duration, only one of the starting and ending times is needed to be entered and the other will be automatically calculated. If the time block were dragged onto a day with no hourly divisions, then the day would be pre-populated and the starting and/or ending time would need to be entered by the user as described above. In step 350, the proposed electronic calendar event is saved in association with a particular calendar location.

### Implementing Mechanisms

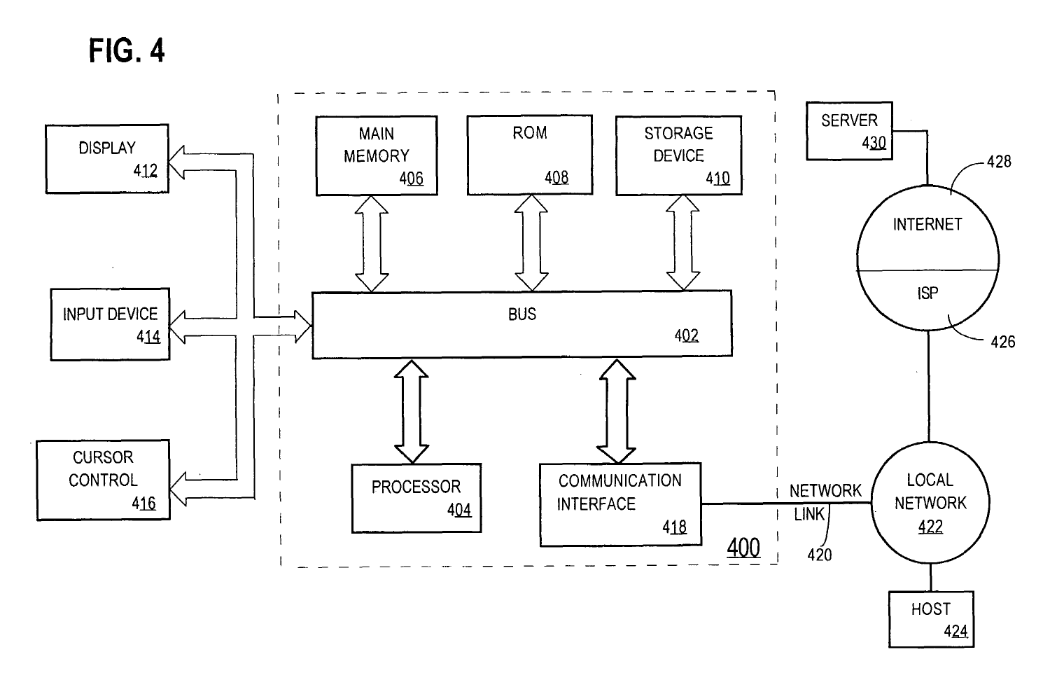

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for creating a calendar event, the computer-implemented method comprising the steps of:
displaying a plurality of graphical elements, each of which is independent of any calendar locations, wherein each graphical element of the plurality of graphical elements is associated with a distinct set of one or more user-specified calendar event characteristics;
in response to user input associated with a particular graphical element of the plurality of graphical elements, generating a proposed calendar event that has a first set of one or more calendar event characteristics that are based on the set of user-specified calendar event characteristics associated with the particular graphical element;
receiving user input defining a second set of one or more calendar event characteristics, wherein the second set of one or more calendar event characteristics are not associated with the particular graphical element; and
causing to be saved the proposed calendar event in association with a particular calendar location.

2. The computer-implemented method of claim 1 wherein the user input associated with a particular graphical element of the plurality of graphical elements comprises dragging the particular graphical element onto an electronic representation of a calendar.

3. The computer-implemented method of claim 1 wherein the user input associated with a particular graphical element of the plurality of graphical elements comprises selecting the particular graphical element.

4. The computer-implemented method of claim 1 wherein the set of one or more user-specified calendar event characteristics comprises at least one of: a date, a starting time, an ending time, and a description of the calendar event.

5. The computer-implemented method of claim 1 further comprising the steps of:
receiving user input selecting the particular graphical element;
receiving user input comprising calendar event characteristics, wherein the user input replaces at least one of the calendar event characteristics in the distinct set of one or more user-specified calendar event characteristics; and
saving the distinct set of one or more user-specified calendar event characteristics so that for at least the next user input associated with the particular graphical element, the user input comprising calendar event characteristics is included in the first set of one or more calendar event characteristics that are based on the set of user-specified calendar event characteristics associated with the particular graphical element.

6. The computer-implemented method of claim 5 wherein the step of saving the distinct set of one or more user-specified calendar event characteristics does not alter any calendar events previously saved.

7. The computer-implemented method of claim 1 wherein the step of generating a proposed calendar event includes:
determining whether the distinct set of one or more user-specified calendar event characteristics includes data describing at least one invitee requested to attend the proposed calendar event;
automatically determining whether the invitee has a calendar event saved on an electronic calendar associated with the invitee that conflicts with the date and time of the proposed calendar event, and if not, automatically saving a copy of the proposed calendar event on the electronic calendar associated with the invitee.

8. A computer-implemented method for creating an electronic calendar event, the computer-implemented method comprising the steps of:
receiving and storing user input comprising at least one characteristic describing an electronic calendar event, wherein said calendar event comprises a plurality of characteristics, and wherein said user input comprises a subset of said plurality of characteristics;
associating said user input with a graphical element;
receiving user input activating said graphical element, wherein said activation causes to be displayed a graphical element in which a plurality of characteristics of an electronic calendar event may be entered in predefined blank data entry fields;
automatically populating at least one of said predefined blank data entry fields with said user input;
receiving user input populating at least one of said predefined blank data entry fields with said user input; and
causing to be saved said electronic calendar event.

9. A computer-readable medium carrying one or more sequences of instructions which, when executed by one or more processors, causes the one or more processors to perform the steps of:
displaying a plurality of graphical elements, each of which is independent of any calendar locations, wherein each graphical element of the plurality of graphical elements is associated with a distinct set of one or more user-specified calendar event characteristics;
in response to user input associated with a particular graphical element of the plurality of graphical elements, generating a proposed calendar event that has a first set of one or more calendar event characteristics that are based on the set of user-specified calendar event characteristics associated with the particular graphical element;
receiving user input defining a second set of one or more calendar event characteristics, wherein the second set of one or more calendar event characteristics are not associated with the particular graphical element; and
causing to be saved the proposed calendar event in association with a particular calendar location.

10. A computer-readable medium carrying one or more sequences of instructions which, when executed by one or more processors, causes the one or more processors to perform the method recited in claim 2.

11. A computer-readable medium carrying one or more sequences of instructions which, when executed by one or more processors, causes the one or more processors to perform the method recited in claim 3.

12. A computer-readable medium carrying one or more sequences of instructions which, when executed by one or more processors, causes the one or more processors to perform the method recited in claim 4.

13. A computer-readable medium carrying one or more sequences of instructions which, when executed by one or more processors, causes the one or more processors to perform the method recited in claim 5.

14. A computer-readable medium carrying one or more sequences of instructions which, when executed by one or more processors, causes the one or more processors to perform the method recited in claim 6.

15. A computer-readable medium carrying one or more sequences of instructions which, when executed by one or more processors, causes the one or more processors to perform the method recited in claim 7.

16. A computer-readable medium carrying one or more sequences of instructions which, when executed by one or more processors, causes the one or more processors to perform the method recited in claim 8.
